(19) United States
(12) Patent Application Publication
(10) Pub. No.: US 2016/0165533 A1
(43) Pub. Date: Jun. 9, 2016

(54) COMMUNICATION METHOD, STATION AND SYSTEM

(71) Applicant: Huawei Technologies Co., Ltd., Shenzhen (CN)

(72) Inventors: Xun YANG, Shenzhen (CN); Yanping JIANG, Shenzhen (CN); Mu ZHAO, Shenzhen (CN)

(21) Appl. No.: 15/047,345

(22) Filed: Feb. 18, 2016

Related U.S. Application Data
(63) Continuation of application No. PCT/CN2013/082480, filed on Aug. 28, 2013.

(51) Int. Cl. H04W 48/20

(52) U.S. Cl. CPC H04W 48/20

(57) ABSTRACT

Embodiments of the present application disclose a communication method, including: a station performs association certification with access points, wherein the access points at least includes a first access point and a second access point; the station sends sequence numbers to the access points; the station broadcasts a communication message for enabling the access points to return reply messages to the station according to the sequence numbers in sequence, after receiving the communication message; the station receives a reply message returned by at least one access point, and performs data communication with the at least one access point which returns the reply message. The present application may be used for solving the problems that in an OBSS system, the probability of STA in an overlapped area for competing to obtain a channel is small and the throughput is low.

### CROSS-REFERENCE TO RELATED APPLICATIONS

This application is a continuation of International Patent Application No. PCT/CN2013/082480, filed on Aug. 28, 2013, which is hereby incorporated by reference in its entirety.

### TECHNICAL FIELD

The present application relates to the technical field of communications, and in particular, to a communication method, a station and a system.

### BACKGROUND

With the rapid development of wireless communication technology, a wireless device, such as an access point (AP) and a station (STA) is deployed more and more, and in a densely deployed wireless local area network, due to a continuous network distribution demand, a signal overlapped area may exist between adjacent basic service sets (BSS). Due to limited spectrum resources, these adjacent BSSs may work on the same channel, resulting in an overlapped basic service set (OBSS) of the adjacent BSSs. The STA in the overlapped area of the adjacent BSSs will be influenced by a plurality of BSSs within a sensing range during a communication process, and the probability of competing to obtain the channel is lower compared with the STA in a non-overlapped area, resulting in lower throughput of the STA in the overlapped area, and even possible information interaction failure when communicating with the AP.

In the prior art, in view of the property that the STA in the overlapped area in the OBSS system may simultaneously receive signals from a plurality of APs, the STA is allowed to mange and communicate with more than one AP, specifically, the STA may be associated with a plurality of APs, and different sleep time is set between different BSSs to awaken the BSSs in turn so as to achieve time division communication with different APs. As shown in FIG. 1, STA1 is in the overlapped area of adjacent BSS1 and BSS2, STA2 is only in a coverage area of the BSS2, and thus the STA1 may simultaneously receive signals from AP1 corresponding to the BSS1 and signals from AP2 corresponding to the BSS2. In the OBSS system, the STA1 in the overlapped area is awakened in the BSS1, when the BSS2 performs information interaction with the STA2, the probability of the STA1 for competing to obtain the channel is still equal to the probability of competing to obtain the channel when being singly in the BSS1. Moreover, as long as any AP in the AP1 corresponding to the BSS1 and the AP2 corresponding to the BSS2 sends information to other STA, the STA1 in the overlapped area cannot compete for the channel, and thus the probability of the STA1 in the overlapped area for competing to obtain the channel to communicate is smaller, and the throughput is lower.

### SUMMARY

Embodiments of the present application provide a communication method, station and system, for solving the problems that in an OBSS system, the probability of STA in an overlapped area for competing to obtain a channel is small and the throughput is low.

A first aspect of the embodiment of the present application provides a communication method, including:

performing, by a station, association certification with access points, and the access points at least include a first access point and a second access point;

sending, by the station, sequence numbers to the first access point and the second access point, and the sequence numbers are used for indicating the sequences of the access points for replying to the station;

broadcasting, by the station, a communication message for enabling the first access point and the second access point to return reply messages to the station according to the sequence numbers in sequence, after receiving the communication message; and

receiving, by the station, a reply message returned by at least one access point in the first access point and the second access point, and performing data communication with the at least one access point which returns the reply message.

In a first possible implementation manner of the first aspect, the receiving, by the station, the reply message returned by at least one access point in the first access point and the second access point, and performing data communication with the at least one access point which returns the reply message, includes:

receiving, by the station, the reply message returned by the first access point or the second access point, and performing data communication with the first access point or the second access point; or

receiving, by the station, the reply messages returned by the first access point and the second access point, and selecting the access point with better channel quality in information interaction to perform data communication according to the channel quality in the information interaction.

In combination with the first possible implementation manner of the first aspect, in a second possible implementation manner, both the first access point and the second access point will return the reply messages when receiving the communication message, the receiving, by the station, the reply message returned by the first access point or the second access point, and performing data communication with the first access point or the second access point, includes:

when receiving the reply message returned by the first access point within a first preset time, directly performing, by the station, data communication with the first access point without waiting for the second access point to return the reply message; if not receiving the reply message returned by the first access point within the first preset time, continuing to wait for, by the station, the second access point to return the reply message; or

when receiving the reply message returned by the first access point within the first preset time, broadcasting, by the station, an acknowledgement message used for indicating that the reply message has been obtained, for enabling the second access point not to return the reply message after receiving the acknowledgement message, and performing, by the station, data communication with the first access point.

In combination with the second possible implementation manner of the first aspect, in a third possible implementation manner, if only the first access point will return the reply message when receiving the communication message, and when not receiving the reply message returned by the first access point within the first preset time, the station broadcasts a request message used for requesting to return the reply message, for enabling the second access point to return the reply message after receiving the request message.

In combination with the first, the second or the third possible implementation manner of the first aspect, in a fourth possible implementation manner, the receiving, by the station, the reply messages returned by the first access point and the second access point, and selecting the access point with better channel quality in information interaction to perform data communication according to the channel quality in the information interaction, includes:

if both the first access point and the second access point will return the reply messages when receiving the communication message, when the station receives the reply messages returned by the first access point and the second access point in sequence, selecting the access point with better channel quality in the information interaction to perform data communication according to the channel quality in the information interaction; or

if only the first access point will return the reply message when receiving the communication message, and when the station receives the reply message returned by the first access point, broadcasting the request message used for requesting to return the reply message, for enabling the second access point to return the reply message after receiving the request message, and selecting, by the station, the access point with better channel quality in the information interaction to perform data communication according to the channel quality in the information interaction.

In combination with the first aspect, or the first, second, third or fourth possible implementation manner of the first aspect, in a fifth possible implementation manner, the communication message is a data message, the data message carries communication data, and the reply message is an acknowledge character; or

the communication message is a request to send RTS message, the reply message is clear to send CTS message, the request to send RTS message is used by the station for requesting the access points to send data, and the clear to send CTS message is used by the access points for allowing the station to send data.

In combination with the fifth possible implementation manner of the first aspect, in a sixth possible implementation manner, if the communication message is RTS and the reply message is CTS, the receiving, by the station, the reply message returned by at least one access point in the first access point and the second access point, and performing data communication with the at least one access point which returns the reply message, includes:

receiving, by the station, the CTS returned by at least one access point in the first access point and the second access point;

determining the access point used for performing data communication according to the CTS returned by at least one access point in the first access point and the second access point; and

sending a data message to the access point determined to communicate, and performing data communication with the access point determined to communicate, wherein the data message carries communication data.

In combination with the first aspect, or the first, second, third, fourth, fifth or sixth possible implementation manner of the first aspect, in a seventh possible implementation manner, if the first access point and the second access point work on the same channel, the station broadcasts the communication message on the channel; if the first access point and the second access point work on different channels, the station broadcasts the communication message on a channel which the first access point works, and in the case of communication failure with the first access point, the station switches to a channel which the second access point works and broadcasts the communication message.

In combination with the first aspect, or the first, second, third, fourth, fifth, sixth or seventh possible implementation manner of the first aspect, in an eighth possible implementation manner, before performing, by the station, data communication with the at least one access point which returns the reply message, the method further includes:

receiving, by the station, a communication setting message sent by an access point which has established a communication connection, and communicating with the access point which has established the communication connection according to the communication setting message;

wherein, the access point which has established the communication connection includes an access point which has performed data communication with the station or an access point which performs no data communication with the station but has been determined by the station as the access point used for performing data communication, and the communication setting message includes at least one of the following information: communication time information and window length information.

A second aspect of the embodiment of the present application provides a station, including:

an association unit, configured to perform association certification with access points, and the access points at least include a first access point and a second access point;

a sending unit, configured to send sequence numbers to the first access point and the second access point, and the sequence numbers are used for indicating the sequences of the access points for replying to the station;

a message broadcasting unit, configured to broadcast a communication message for enabling the first access point and the second access point to return reply messages to the station according to the sequence numbers in sequence, after receiving the communication message; and

a receiving unit, configured to receive the reply message returned by at least one access point in the first access point and the second access point, and perform data communication with the at least one access point which returns the reply message.

In a first possible implementation manner of the second aspect, the receiving unit is specifically configured to:

receive the reply message returned by the first access point or the second access point, and perform data communication with the first access point or the second access point; or

receive the reply messages returned by the first access point and the second access point, and select the access point with better channel quality in information interaction to perform data communication according to the channel quality in the information interaction.

In combination with the first possible implementation manner of the second aspect, in a second possible implementation manner, if both the first access point and the second access point will return the reply messages when receiving the communication message, the receiving unit is specifically configured to:

when receiving the reply message returned by the first access point within a first preset time, directly perform data communication with the first access point without waiting for the second access point to return the reply message; if the receiving unit does not receive the reply message returned by the first access point within the first preset time, continue to wait for the second access point to return the reply message; or

when receiving the reply message returned by the first access point within the first preset time, indicate the message broadcasting unit to broadcast an acknowledgement message used for indicating that the reply message has been obtained, for enabling the second access point not to return the reply message after receiving the acknowledgement message, and the receiving unit performs data communication with the first access point.

In combination with the second possible implementation manner of the second aspect, in a third possible implementation manner, if only the first access point will return the reply message when receiving the communication message, and when not receiving the reply message returned by the first access point within the first preset time, the receiving unit indicates the message broadcasting unit to broadcast a request message used for requesting to return the reply message, for enabling the second access point to return the reply message after receiving the request message.

In combination with the first, second or third possible implementation manner of the second aspect, in a fourth possible implementation manner, the receiving unit is specifically configured to:

if both the first access point and the second access point will return the reply messages when receiving the communication message, when the receiving unit receives the reply messages returned by the first access point and the second access point in sequence, select the access point with better channel quality in the information interaction to perform data communication according to the channel quality in the information interaction; or

if only the first access point will return the reply message when receiving the communication message, and when the receiving unit receives the reply message returned by the first access point, indicate the message broadcasting unit to broadcast the request message used for requesting to return the reply message, for enabling the second access point to return the reply message after receiving the request message, and the receiving unit selects the access point with better channel quality in the information interaction to perform data communication according to the channel quality in information interaction.

In combination with the second aspect, or the first, second, third or fourth possible implementation manner of the second aspect, in a fifth possible implementation manner, the communication message is a data message, the data message carries communication data, and the reply message is an acknowledge character; or

the communication message is a request to send RTS message, the reply message is clear to send CTS message, the request to send RTS message is used by the station for requesting the access points to send data, and the clear to send CTS message is used by the access points for allowing the station to send data.

In combination with the fifth possible implementation manner of the first aspect, in a sixth possible implementation manner, if the communication message is RTS and the reply message is CTS, the receiving unit is specifically configured to:

receive the CTS returned by at least one access point in the first access point and the second access point;

determine the access point used for performing data communication according to the CTS returned by at least one access point in the first access point and the second access point; and

send a data message to the access point determined to communicate, and perform data communication with the access point determined to communicate, wherein the data message carries communication data.

In combination with the second aspect, or the first, second, third, fourth, fifth or sixth possible implementation manner of the second aspect, in a seventh possible implementation manner, the station further includes:

a channel switching unit configured to, if the first access point and the second access point work on the same channel, the message broadcasting unit broadcasts the communication message on the channel; if the first access point and the second access point work on different channels, the message broadcasting unit broadcasts the communication message on a channel which the first access point works, and in the case of communication failure with the first access point, the channel switching unit switches to a channel which the second access point works and indicates the message broadcasting unit to broadcast the communication message.

In combination with the second aspect, or the first, second, third, fourth, fifth, sixth or seventh possible implementation manner of the second aspect, in an eighth possible implementation manner, the receiving unit is further configured to:

receive a communication setting message sent by an access point which has established a communication connection, and communicate with the access point which has established the communication connection according to the communication setting message;

wherein, the access point which has established the communication connection includes an access point which has performed data communication with the station or an access point which performs no data communication with the station but has been determined by the station as the access point used for performing data communication, and the communication setting message includes at least one of the following information: communication time information and window length information.

A third aspect of the embodiment of the present application provides a computer program product, including a computer readable medium, wherein the computer readable medium includes a group of program codes used for executing the method in the first aspect or any implementation manner of the first aspect of the embodiment of the present application.

A fourth aspect of the embodiment of the present application provides a system, including:

the station in the second aspect or any implementation manner of the second aspect of the embodiment of the present application;

at least two access points, configured to perform association certification with the station, receive corresponding sequence numbers sent by the station, wherein the sequence numbers are used for indicating the sequences of the access points for replying to the station, and when receiving a communication message broadcast by the station, return reply messages to the station according to the sequence numbers in sequence, for enabling the station to receive the reply message returned by at least one access point and perform data communication with the at least one access point which returns the reply message.

In a first possible implementation manner of the fourth aspect, if the station establishes a communication connection with any access point in the at least two access points, the access point, which has established the communication connection with the station, is further configured to send a communication setting message to the station, for enabling the station to perform data communication with the access point, which has established the communication connection with the station, according to the communication setting message;

wherein, the access point which has established the communication connection includes an access point which performs data communication with the station or an access point which performs no data communication with the station but has been determined by the station as the access point used for performing data communication, and the communication setting message includes at least one of the following information: communication time information and window length information.

By implementing the embodiments of the present application, the following beneficial effects are produced:

in an OBSS system, the sequence numbers are allocated to the access points to enable the access points to respond to the communication message of the station in sequence, in this way, the station located in an overlapped area of adjacent BSSs may attempt to establish the communication connection with a plurality of access points, namely the station may compete the channel in two BSSs simultaneously, thereby increasing the probability of the station for competing to obtain the channel and sending data, and being conducive to improving the throughput of the station.

### BRIEF DESCRIPTION OF DRAWINGS

To illustrate technical solutions in embodiments of the present application or in the prior art more clearly, a brief introduction on the accompanying drawings which are needed in the description of the embodiments is given below. Apparently, the accompanying drawings in the description below are merely some of the embodiments of the present application, based on which other drawings may be obtained by those of ordinary skill in the art without any creative effort.

FIG. 1 is a schematic diagram of a scenario of an OBSS system;

FIG. 2 is a schematic diagram of a flow of embodiment 1 of a communication method in the present application;

FIG. 3 is a schematic diagram of a flow of embodiment 2 of a communication method in the present application;

FIG. 4 is a schematic diagram of a flow of embodiment 3 of a communication method in the present application;

FIG. 5 is a schematic diagram of a flow of embodiment 4 of a communication method in the present application;

FIG. 6 is a schematic diagram of a flow of embodiment 5 of a communication method in the present application;

FIG. 7 is a schematic diagram of a flow of embodiment 6 of a communication method in the present application;

FIG. 8 is a schematic diagram of a flow of embodiment 7 of a communication method in the present application;

FIG. 9 is a schematic diagram of a flow of embodiment 8 of a communication method in the present application;

FIG. 10 is a schematic diagram of a flow of embodiment 9 of a communication method in the present application;

FIG. 11 is a schematic diagram of a flow of embodiment 10 of a communication method in the present application;

FIG. 12 is a schematic diagram of a flow of embodiment 11 of a communication method in the present application;

FIG. 13 is a schematic diagram of a flow of embodiment 12 of a communication method in the present application;

FIG. 14 is a schematic diagram of composition of embodiment 1 of a station in the present application;

FIG. 15 is a schematic diagram of composition of embodiment 2 of a station in the present application;

FIG. 16 is a schematic diagram of composition of embodiment 3 of a station in the present application;

FIG. 17 is a schematic diagram of composition of a system in the embodiment of the present application.

### DESCRIPTION OF EMBODIMENTS

A clear and complete description of technical solutions in the embodiments of the present application will be given below, in combination with the accompanying drawings in the embodiments of the present application. Apparently, the embodiments described below are merely a part, but not all, of the embodiments of the present application. All of other embodiments, obtained by those of ordinary skill in the art based on the embodiments of the present application without any creative effort, fall into the protection scope of the present application.

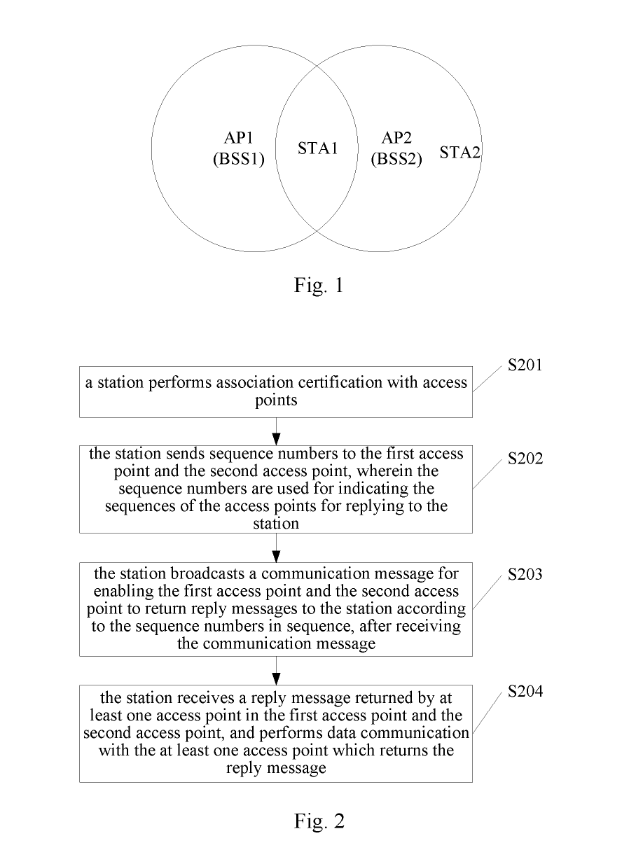

Please refer to FIG. 2, it is a schematic diagram of a flow of embodiment 1 of a communication method in the present application, and in the embodiment, the method includes the following steps:

S201, a station performs association certification with access points.

Wherein, the access points at least include a first access point and a second access point.

Specifically, the station may obtain information of the access points located in a working area of the station by scanning a channel. The first access point and the second access point may work on the same channel and may also work on different channels. The scanning herein may be actively initiated by the station and may also be that the station accepts the requirement of the access points to passively scan the channel. This is not limited in the embodiment.

S202, the station sends sequence numbers to the first access point and the second access point, wherein the sequence numbers are used for indicating the sequences of the access points for replying to the station.

Wherein, the sequence numbers are used for indicating order for replying to the station by the access points.

For example, if two access points in the working area are found by the station when scanning the channel, the station may send the sequence numbers to the two access points after performing association certification with the two access points. The sequence number capable of being obtained by each access point is generally different.

S203, the station broadcasts a communication message for enabling the first access point and the second access point to return reply messages to the station according to the sequence numbers in sequence, after receiving the communication message.

Specifically, the communication message is a data message, the data message carries communication data, and the reply message is an acknowledge character ACK; or the communication message is a request to send a request to send (RTS) message, the reply message is a clear to send a clear to send (CTS) message, the request to send RTS message is used by the station for requesting the access points to send data, and the clear to send CTS message is used by the access points for allowing the station to send data.

The communication message may carry data, the station directly attempts to perform data communication with the access point, for example, directly broadcasts the data message, waits for the access point to return the acknowledge character ACK and determine whether successfully communicating with a certain access point according to the returned ACK; of course, the communication message may not carry data, the station waits until that the access point is determined to communicate, and sends a message carrying data, for example, broadcasts RTS message, waits for returning CTS message, determines the access point to communicate according to the returned CTS and sends the data message.

S204, the station receives a reply message returned by at least one access point in the first access point and the second access point, and performs data communication with the at least one access point which returns the reply message.

Specifically, when receiving the reply message returned by any access point, the station may establish a communication connection with the access point, may also wait for more than one or all the association certified access points to return the reply messages, and then select the access point with better channel quality to communicate according to the channel quality embodied when sending and receiving the communication message or the reply messages. Therefore, interference is reduced and communication quality is improved.

Of course, under some specific scenarios, the station may also perform data communication simultaneously with two or more access points which return the reply messages.

In the embodiment, the station will allocate corresponding sequence numbers to arbitrary associated access points, for indicating the sequences of the access points for replying to the station. For example, the sequence number of the first access point is 1, and the sequence number of the second access point is 2, then when the both receive the communication message of the station, the first access point returns the reply message and then the second access point returns the reply message according to the sequence. In this way, in an OBSS system, the sequence numbers are allocated to the access points to enable the access points to respond to the communication message of the station in sequence, in this way, the station located in an overlapped area of adjacent BSSs may attempt to establish the communication connection with a plurality of access points, namely, the station may compete the channel in two BSSs at the same time, thereby increasing the probability of the station for competing to obtain the channel and sending data and being conducive to improving the throughput of the station, and moreover, interference on the station in the overlapped area in the communication process may be reduced.

It should be noted that, the BSS in the embodiment may be a BSS based on an infrastructure Infrastructure mode and may also based on an ad-hoc mode ad-hoc. The station may simultaneously compete for the channel in networks of the two modes. When the station communicates with a plurality of access points, basic service set identities (BSSID) of the BSSs where these access points are located may be the same or different. When the BSSID is the same, a corresponding bit of the data frame or a medium access control (MAC) frame header in RTS sent by the station may be set as the BSSID. When the BSSIDs are different, if these access points work on the same channel, the corresponding bit in the data frame or the MAC frame header in the RTS sent by the station may be set as a wildcard character.

In addition, before communicating with a plurality of access points, the station may negotiate with the plurality of access points on the communication durations of the plurality of access points. The communication with the plurality of access points may be temporary and may also be long-term. The negotiation information may be a new command or be contained in the an existing control frame, a management frame or a data frame, for example, an association request frame and a re-association request frame.

The embodiment only describes the communication flow of the station in the overlapped area in the OBSS system with the two access points, when more than three access points exist, the communication flow is similar, and will not be repeated redundantly herein.

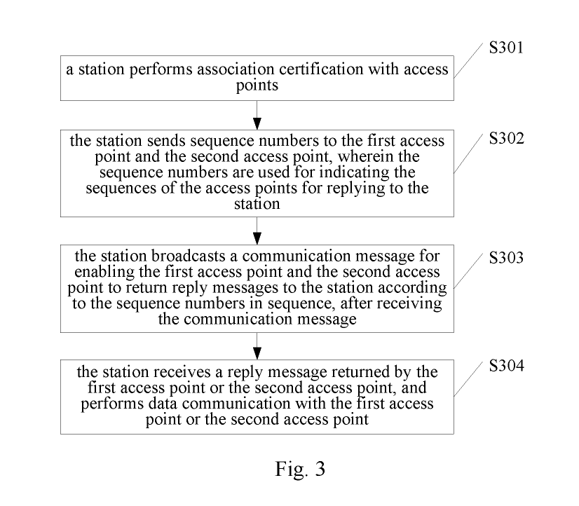

Please refer to FIG. 3, it is a schematic diagram of a flow of a second embodiment of a communication method in the present application, and in the embodiment, the method includes the following steps:

S301, a station performs association certification with access points.

Wherein, the access points at least include a first access point and a second access point.

S302, the station sends sequence numbers to the first access point and the second access point, wherein the sequence numbers are used for indicating the sequences of the access points for replying to the station.

S303, the station broadcasts a communication message for enabling the first access point and the second access point to return reply messages to the station according to the sequence numbers in sequence, after receiving the communication message.

S304, the station receives a reply message returned by the first access point or the second access point, and performs data communication with the first access point or the second access point.

Specifically, if the sequence corresponding to the sequence number of the first access point is prior to the sequence corresponding to the sequence number of the second access point, the reply message returned by the first access point will be received at first.

More specifically, if both the first access point and the second access point will return the reply messages when receiving the communication message, when receiving the reply message returned by the first access point within a first preset time, the station directly performs data communication with the first access point without waiting for the second access point to return the reply message; if not receiving the reply message returned by the first access point within the first preset time, the station continues to wait for the second access point to return the reply message, and if receiving the reply message returned by the second access point within the second preset time, the station performs data communication with the second access point; if not receiving the reply message returned by the second access point within the second preset time, the station decides communication failure; or when receiving the reply message returned by the first access point within the first preset time, the station broadcasts an acknowledgement message used for indicating that the reply message has been obtained, for enabling the second access point not to return the reply message after receiving the acknowledgement message, and the station performs the data communication with the first access point.

Wherein, if only the first access point will return the reply message when receiving the communication message, and when not receiving the reply message returned by the first access point within the first preset time, the station broadcasts a request message used for requesting to return the reply message, for enabling the second access point to return the reply message after receiving the request message.

If receiving the reply message returned by the second access point within the second preset time, the station performs data communication with the second access point; if not receiving the reply message returned by the second access point within the second preset time, the station decides communication failure.

It should be noted that, if the first access point and the second access point work on the same channel, the station broadcasts the communication message on the channel; if the first access point and the second access point work on different channels, the station broadcasts the communication message on a channel where the first access point works, and in the case of communication failure with the first access point, the stations replaces to a channel where the second access point works and broadcasts the communication message. Therefore, the station is guaranteed to communicate with the access points working on different channels, to increase the probability of the station for competing to obtain the channel.

In the embodiment, the flow of successfully receiving the reply message returned by any access point and performing data communication is mainly described, since waiting for other access point to return the reply message is not needed, the communication method in the embodiment may be used for determining the access point to communicate more quickly, and thus the data communication efficiency is improved.

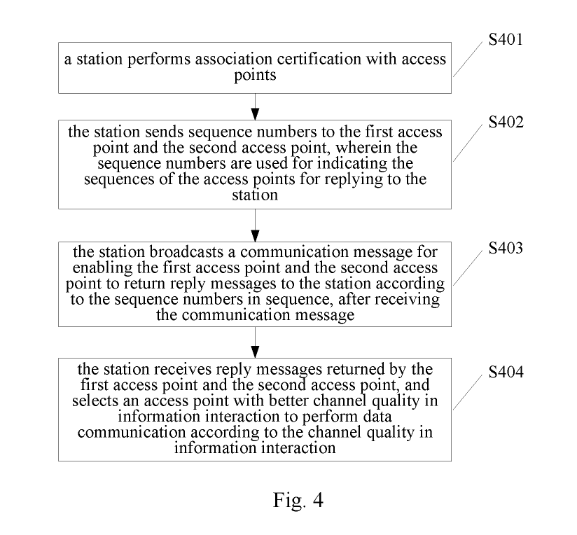

Please refer to FIG. 4, it is a schematic diagram of a flow of embodiment 3 of a communication method in the present application, and in the embodiment, the method includes the following steps:

S401, a station performs association certification with access points.

Wherein, the access points at least include a first access point and a second access point.

S402, the station sends sequence numbers to the first access point and the second access point, wherein the sequence numbers are used for indicating the sequences of the access points for replying to the station.

S403, the station broadcasts a communication message for enabling the first access point and the second access point to return reply messages to the station according to the sequence numbers in sequence, after receiving the communication message.

S404, the station receives reply messages returned by the first access point and the second access point, and selects an access point with better channel quality in information interaction to perform data communication according to the channel quality in information interaction.

Specifically, may include: if both the first access point and the second access point will return the reply message when receiving the communication message, when receiving the reply messages returned by the first access point and the second access point in sequence, the station selects the access point with better channel quality in the information interaction to perform data communication according to the channel quality in the information interaction; or

if the access point with the first sequence number in all the access points is configured to return the reply message on the access point side, for reducing the overall system power consumption and shortening the waiting time of the station, namely, in the embodiment, if only the first access point will return the reply message when receiving the communication message, then when receiving the reply message returned by the first access point, the station broadcasts the request message used for requesting to return the reply message, for enabling the second access point to return the reply message after receiving the request message, and the station selects the access point with better channel quality in the information interaction to perform data communication according to the channel quality in the information interaction.

In the embodiment, a method for selecting the access point to communicate according to the reply messages returned by a plurality of or all the access points is provided in the embodiment, although waiting for the plurality of access points to return the reply messages is needed, the station may select the access point with better channel quality to perform the communication according to the channel quality in the information interaction, which is conducive to improving the communication quality of the selected access point.

It should be noted that, different implementation manners are adopted in embodiment 2 and embodiment 3 for improving the overall working efficiency of the station, and in specific implementation, proper selection may be made according to actual conditions, for example, the number of the access points, and the like. If the number of the access points is small, the access point with better channel quality may be selected for communication after waiting for the plurality of access points to return the reply messages, and if the number of the access points is large, when receiving the reply message returned by any access point, the access point may be determined as the communication access point and the data communication is performed.

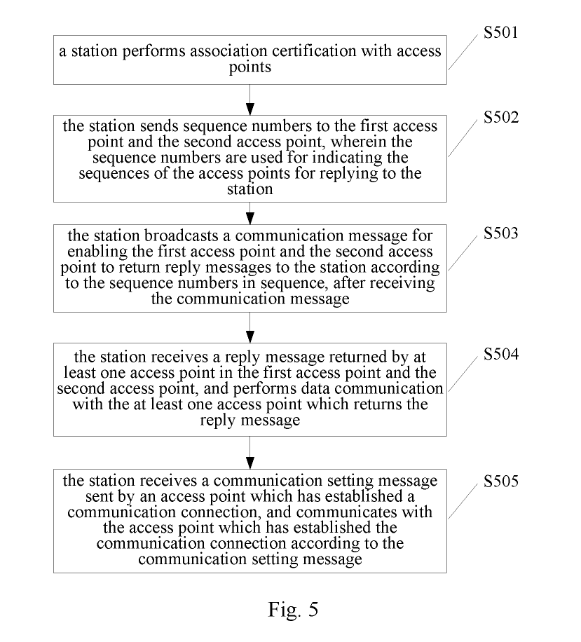

Please refer to FIG. 5, it is a schematic diagram of a flow of embodiment 4 of a communication method in the present application, and in the embodiment, the method includes the following steps:

S501, a station performs association certification with access points.

Wherein, the access points at least include a first access point and a second access point.

S502, the station sends sequence numbers to the first access point and the second access point, wherein the sequence numbers are used for indicating the sequences of the access points for replying to the station.

S503, the station broadcasts a communication message for enabling the first access point and the second access point to return reply messages to the station according to the sequence numbers in sequence, after receiving the communication message.

S504, the station receives a reply message returned by at least one access point in the first access point and the second access point, and performs data communication with the at least one access point which returns the reply message.

S505, the station receives a communication setting message sent by an access point which has established a communication connection, and communicates with the access point which has established the communication connection according to the communication setting message.

Wherein, the access point which has established the communication connection includes an access point which has performed data communication with the station or an access point which performs no data communication with the station but has been determined by the station as the access point used for performing data communication, and the communication setting message includes at least one of the following information: communication time information and window length information.

Specifically, if the access points working on the same channel and associated with the same station want to send downlink data to the station, a plurality of access points may send the data in a competitive mode. Different communication and window lengths may be set to avoid the conflict resulting from simultaneous communication of the plurality of access points with the same station. Corresponding parameter information may be notified by a new command or carried in an existing data frame, a management frame or a control frame. Moreover, within a communication time indicated by the communication time information, the station may continuously or discontinuously communicate with the access point which has established the communication connection for arbitrary times.

A communication process of a communication scenario of the station and two access points will be illustrated below.

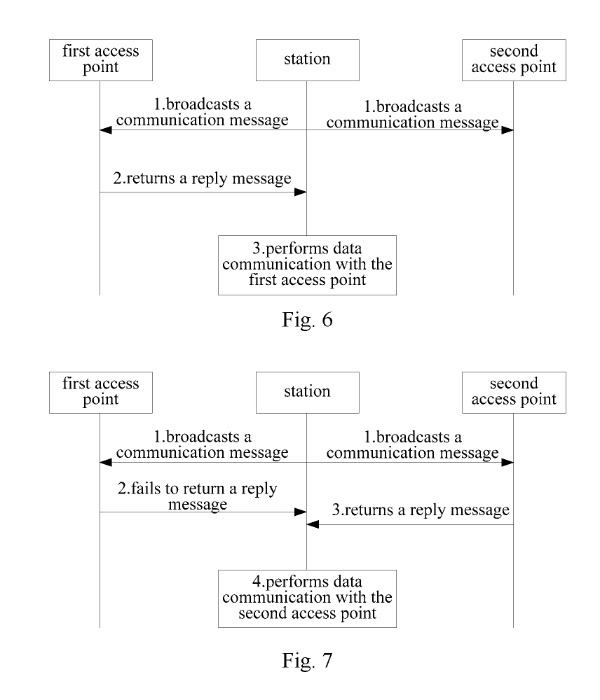

Please refer to FIG. 6 to FIG. 10, they are schematic diagrams of flows of embodiments 5 to 9 of a communication method respectively in the present application, and in these embodiments, both the first access point and the second access point will return a reply message when receiving a communication message of the station, as shown in FIG. 6:

the station broadcasts the communication message, and after the first access point returns the reply message, the station may perform data communication with the first access point. The communication message herein may be a data message carrying data and may also be RTS, and correspondingly, the reply message may be ACK and may also be CTS.

If the first access point fails to return the reply message, then as shown in FIG. 7, the station may wait for the second access point to return the reply message and performs data communication with the second access point.

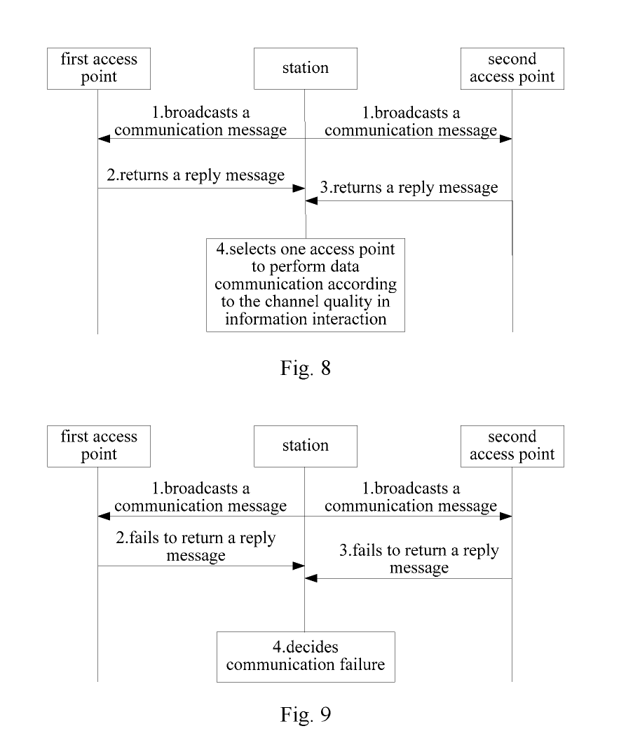

If both the first access point and the second access point successfully return the reply messages according to the sequences corresponding to the sequence numbers, then as shown in FIG. 8, the station may select an access point with better channel quality in information interaction to perform data communication according to the channel quality in information interaction.

If both the access points fail to return a reply message, then as shown in FIG. 9, the station decides communication failure. Of course, if a third access point is also present, the station may continue to wait for the third access point to return a reply message.

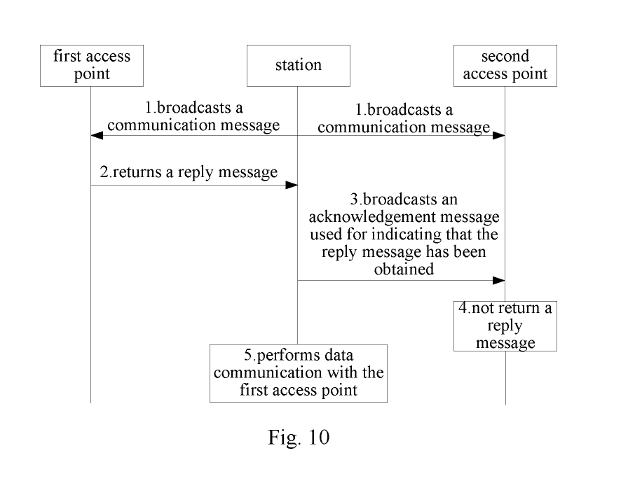

If the station only needs to obtain a reply message of one access point, the station performs data communication with the access point, then as shown in FIG. 10, after receiving the reply message returned by the first access point, the station broadcasts an acknowledgement message used for indicating that the reply message has been obtained, for enabling the second access point not to return a reply message after receiving the acknowledgement message, and the station performs data communication with the first access point. In this way, when the number of the access points is large, the plurality of access points may be avoided of returning the reply messages, thereby reducing the signaling cost and saving signaling and channel resources. The acknowledgement message may carry the identity of the first access point for enabling other access points to understand the access point which performs data communication with the station.

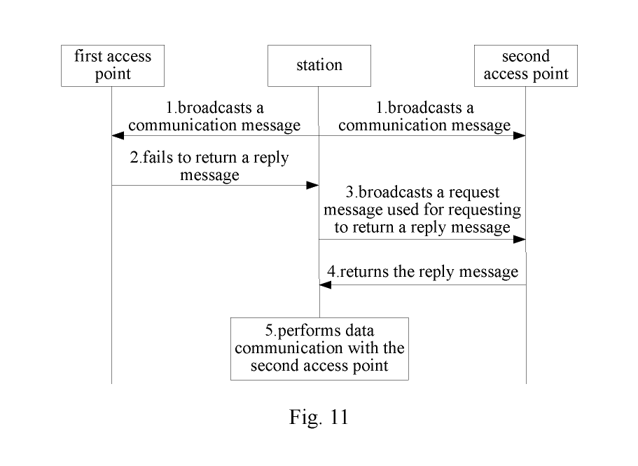

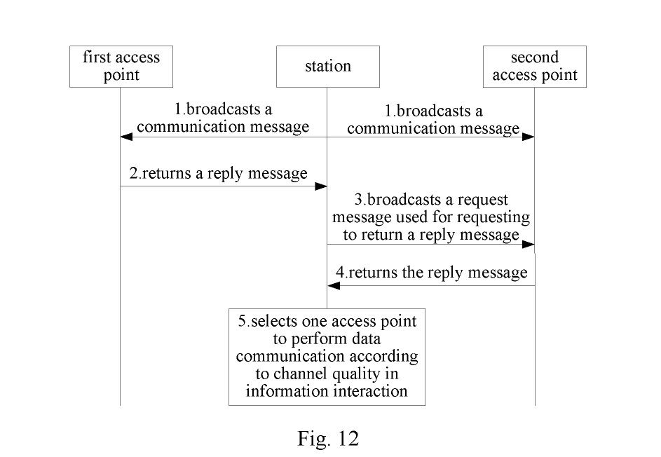

Please refer to FIG. 11 to FIG. 12, they are schematic diagrams of flows of embodiments 10 and 11 of a communication method respectively in the present application, and in these embodiments, in the first access point and the second access point, only the first access point will actively return the reply message when receiving the communication message of the station, as shown in FIG. 11:

the station broadcasts the communication message, the first access point fails to return a reply message, at this time, the station may broadcast a request message used for requesting to return a reply message, for enabling the second access point to return the reply message, so as to perform data communication with the second access point. The communication message herein may be a data message carrying data and may also be RTS, and correspondingly, the reply message may be ACK and may also be CTS. The request message may carry the identity of the first access point for enabling other access points to understand the access point which does not return a reply message. After receiving the request message, the first access point may return the reply message or not, and this is not limited herein.

If the first access point successfully returns a reply message, but the station still wants to receive a reply message of other access point, then as shown in FIG. 12, the station broadcasts a request message used for requesting to return a reply message, the second access point returns the reply message, and the station selects one access point to perform data communication according to channel quality in information interaction.

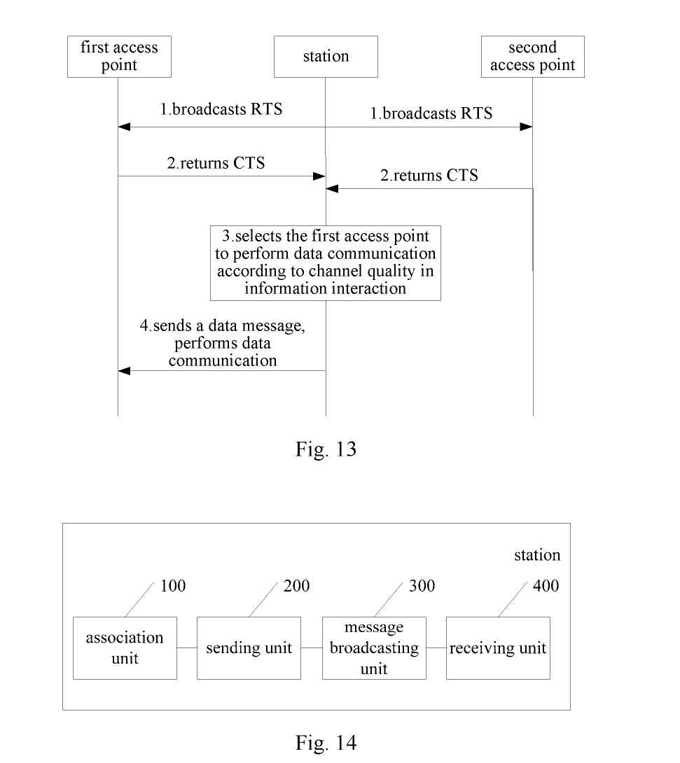

Please refer to FIG. 13, it is a schematic diagram of a flow of embodiment 12 of a communication method in the present application, and in the embodiment, the method includes the following steps:

1. A station broadcasts RTS.

2. A first access point and a second access point return CTS according to sequences corresponding to sequence numbers.

3. The station selects the first access point to perform data communication according to channel quality in information interaction. (It is assumed that the channel quality in the information interaction of the station and the first access point is better)

4. The station sends a data message to the first access point to perform data communication. The data message carries data.

It should be noted that, if the RTS broadcasting manner is adopted in the embodiment, the data communication may be performed only after determining the access point to communicate, in the process of determining the access point, a large amount of data does not need to be carried, then channel resources may be saved. In the communication method in the fifth to the eleventh embodiments of the present application as shown in FIG. 6 to FIG. 12, when the communication message is directly a data message carrying the data, once data communication may be completed in the process of determining the access point to communicate, in this way, times of information interaction may be decreased. Of course, the flow of the communication method as shown in FIG. 6 to FIG. 12 is also applicable when the communication message is RTS, and only a flow of sending the data message is added after determining the access point to communicate.

Please refer to FIG. 14, it is a schematic diagram of composition of a first embodiment of a station in the present application, in the embodiment, the station includes: an association unit 100, a sending unit 200, a message broadcasting unit 300 and a receiving unit 400.

The association unit 100 is configured to perform association certification with access points.

The access points at least include a first access point and a second access point.

The sending unit 200 is configured to send sequence numbers to the first access point and the second access point, and the sequence numbers are used for indicating the sequences of the access points for replying to the station;

the message broadcasting unit 300 is configured to broadcast a communication message for enabling the first access point and the second access point to return reply messages to the station according to the sequence numbers in sequence, after receiving the communication message;

the receiving unit 400 is configured to receive a reply message returned by at least one access point in the first access point and the second access point, and perform data communication with the at least one access point which returns the reply message.

The receiving unit 400 is specifically configured to:

receive the reply message returned by the first access point or the second access point, and perform data communication with the first access point or the second access point; or

receive the reply messages returned by the first access point and the second access point, and select an access point with better channel quality in information interaction to perform data communication according to the channel quality in the information interaction.

More specifically, the receiving unit 400 is specifically configured to:

if both the first access point and the second access point will return the reply messages when receiving the communication message, the receiving unit is specifically configured to: when receiving the reply message returned by the first access point within a first preset time, directly perform data communication with the first access point without waiting for the second access point to return a reply message; if the receiving unit does not receive the reply message returned by the first access point within the first preset time, continue to wait for the second access point to return a reply message; or

when receiving the reply message returned by the first access point within the first preset time, indicate the message broadcasting unit 300 to broadcast an acknowledgement message used for indicating that the reply message has been obtained, for enabling the second access point not to return a reply message after receiving the acknowledgement message, and the receiving unit 400 performs data communication with the first access point.

If only the first access point will return the reply message when receiving the communication message, and when not receiving the reply message returned by the first access point within the first preset time, the receiving unit 400 indicates the message broadcasting unit 300 to broadcast a request message used for requesting to return the reply message, for enabling the second access point to return the reply message after receiving the request message.

The receiving unit 400 is specifically configured to:

if both the first access point and the second access point will return the reply messages when receiving the communication message, when the receiving unit 400 receives the reply messages returned by the first access point and the second access point in sequence, select an access point with better channel quality in the information interaction to perform data communication according to the channel quality in the information interaction; or

if only the first access point will return the reply message when receiving the communication message, and when the receiving unit receives the reply message returned by the first access point, indicate the message broadcasting unit 300 to broadcast the request message used for requesting to return the reply message, for enabling the second access point to return the reply message after receiving the request message, and the receiving unit 400 selects an access point with better channel quality in the information interaction to perform data communication according to the channel quality in the information interaction.

Wherein, the communication message is a data message, the data message carries communication data, and the reply message is an acknowledge character; or the communication message is a request to send RTS message, the reply message is clear to send CTS message, the request to send RTS message is used by the station for requesting the access points to send data, and the clear to send CTS message is used by the access points for allowing the station to send data.

If the communication message is RTS and the reply message is CTS, the receiving unit 400 is specifically configured to:

receive the CTS returned by at least one access point in the first access point and the second access point;

determine an access point performing data communication according to the CTS returned by the at least one access point in the first access point and the second access point;

send a data message to the access point determined to communicate, and perform data communication with the access point determined to communicate, wherein the data message carries communication data.

The receiving unit 300 is further configured to:

receive a communication setting message sent by an access point which has established a communication connection, and communicate with the access point which has established the communication connection according to the communication setting message;

wherein, the communication setting message includes at least one of the following information: communication time information and window length information.

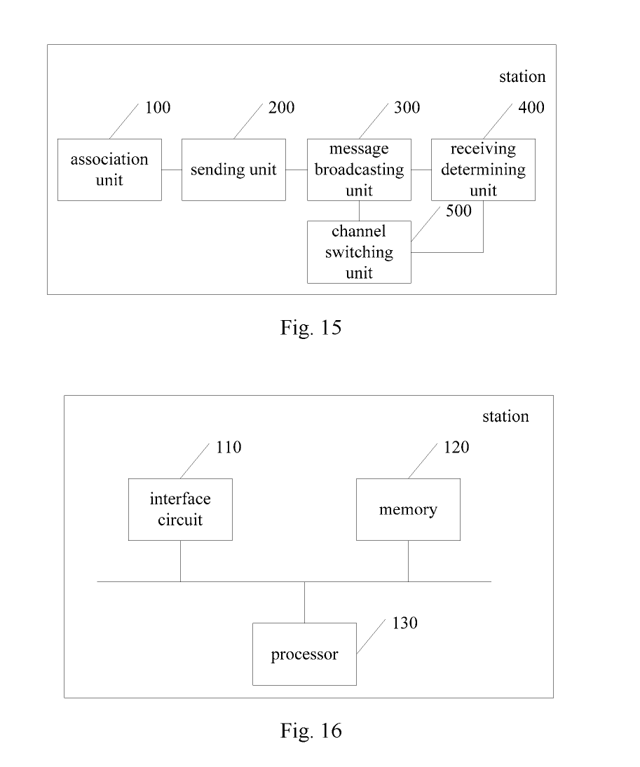

Please refer to FIG. 15, it is a schematic diagram of composition of a second embodiment of a station in the present application, in the embodiment, the station includes: an association unit 100, a sending unit 200, a message broadcasting unit 300, a receiving unit 400 and a channel switching unit 500.

The association unit 100 is configured to perform association certification with access points.

The access points at least include a first access point and a second access point.

The sending unit 200 is configured to send sequence numbers to the first access point and the second access point, and the sequence numbers are used for indicating the sequences of the access points for replying to the station;

the message broadcasting unit 300 is configured to broadcast a communication message for enabling the first access point and the second access point to return reply messages to the station according to the sequence numbers in sequence, after receiving the communication message;

the receiving unit 400 is configured to receive a reply message returned by at least one access point in the first access point and the second access point, and perform data communication with the at least one access point which returns the reply message;

the channel switching unit 500 is configured to, if the first access point and the second access point work on the same channel, the message broadcasting unit 300 broadcasts the communication message on the channel; if the first access point and the second access point work on different channels, the message broadcasting unit 300 broadcasts the communication message on a channel where the first access point works, and in the case of communication failure with the first access point, the channel switching unit 500 switches to a channel where the second access point works and indicates the message broadcasting unit 300 to broadcast the communication message.

It should be noted that, the above-mentioned association unit may be integrated by an association subunit and a certification subunit and may also exist independently, and the receiving unit may be integrated by a receiving subunit and a communication subunit and may also exist independently. Moreover, the association unit and/or the receiving unit in the above-mentioned station embodiment may be singly arranged independent from a processor of the station in a hardware form and is set in a microprocessor form, may also be embedded into the processor of the station in the hardware form, and may also be stored in a memory of the station in a software form, for enabling the processor of the station to dispatch and execute the corresponding operations of the association unit and/or the receiving unit above-mentioned.

For example, in the first embodiment (the embodiment as shown in FIG. 14) of the station in the present application, the association unit 100 and/or the receiving unit 400 may be the processor of the station, and the functions of the sending unit 200 and the message broadcasting unit 300 are embedded into the processor. In addition, the channel switching unit 500 as shown in FIG. 15, together with the association unit 100 or the receiving unit 400, may be singly arranged independent from the processor, may also be embedded into the processor and may also be stored in the memory in the software form to be dispatched by the processor to achieve the functions thereof. Of course, the sending unit 200 and the message broadcasting unit 300 may be integrally arranged and may also be independently arranged, the sending unit 200 and the message broadcasting unit 300 may serve as interface circuits of the station, may be integrated with the association unit 100, the receiving unit 400 or the channel switching unit 500, and may also be independently arranged. This is not limited in the embodiment of the present application. The processor above-mentioned may be a central processing unit (CPU), a microprocessor, a single chip or the like.

Please refer to FIG. 16, it is a schematic diagram of composition of a third embodiment of a station in the present application, in the embodiment, the station includes: an interface circuit 110, a memory 120 and a processor 130 connected with the interface circuit 110 and the memory 120. Wherein, the memory 120 is used for storing a group of program codes, and the processor 130 is used for dispatching the program codes stored in the memory 120 to execute the operations in any one of the first to the twelfth embodiments of the communication method in the present application.

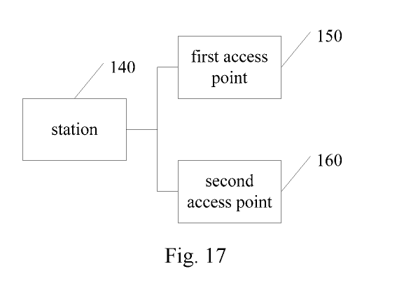

Please refer to FIG. 17, it is a schematic diagram of composition of an embodiment of a system in the present application, and in the embodiment, the system includes:

a station 140 in any one of the first to the third embodiments of the present application;

a first access point 150 and a second access point 160.

The first access point 150 and the second access point 160 are configured to perform association certification with the station 140, receive corresponding sequence numbers sent by the station 140, wherein the sequence numbers are used for indicating the sequences of the access points for replying to the station, and when receiving a communication message broadcast by the station 140, return reply messages to the station 140 according to the sequence numbers in sequence, for enabling the station 140 to receive a reply message returned by at least one access point and to perform data communication with the at least one access point which returns the reply message.

If the station 140 establishes a communication connection with any access point in the at least two access points, the access point, which has established the communication connection with the station 140, is further configured to send a communication setting message to the station 140, for enabling the station 140 to perform data communication with the access point, which has established the communication connection with the station, according to the communication setting message;

wherein, the access point which has established the communication connection includes an access point which performs the data communication with the station 140 or an access point which performs no data communication with the station 140 but has been determined by the station 140 as the access point used for performing data communication, and the communication setting message includes at least one of the following information: communication time information and window length information.

Of course, the condition of two access points is merely described in the embodiment, in an OBSS system, the station may scan three or more access points, the communication process is similar to that of the condition of only two access points, and will not be repeated redundantly herein.

It should be noted that, the embodiments in the description are described in a progressive manner, what is highlighted in each embodiment is difference with other embodiments, and the identical or similar parts among the embodiments may refer to each other. For the apparatus embodiment, it is basically similar to the method embodiments, thus is described simply, and the related parts may refer to a part of illustration to the method embodiments.

By means of the descriptions in the embodiments above-mentioned, the present application has the following advantages:

in the OBSS system, the sequence numbers are allocated to the access points to enable the access points to respond to the communication message of the station in sequence, in this way, the station located in an overlapped area of adjacent BSSs may attempt to establish the communication connection with a plurality of access points, namely, the station may compete the channel in two BSSs simultaneously, thereby increasing the probability of the station for competing to obtain the channel and sending data and being conducive to improving the throughput of the station.

Those of ordinary skill in the art may understand that all or a part of the steps in the above-mentioned method embodiments may be implemented with a program instructing corresponding hardware, the foregoing program may be stored in a computer readable storage medium, and when the program is executed, the steps of the above-mentioned method embodiments included may be executed; the foregoing storage medium includes a variety of media capable of storing program codes, such as an ROM, an RAM, a magnetic disk, an optical disk or the like.

The communication method, station and system provided in the embodiments of the present application have been described above in detail, the principles and implementation manners of the present application are illustrated in this paper by using specific examples, and the illustration of the above embodiments is merely used for helping to understand the method and the core concept thereof of the present application; meanwhile, those of ordinary skill in the art will make variations on specific implementation manners and application ranges according to the concept of the present application, to sum up, the contents in the description should not be understood as a limitation of the present application.

What is claimed is:

1. A communication method, comprising:
performing, by a station, association certification with access points, wherein the access points at least comprises a first access point and a second access point;
sending, by the station, sequence numbers to the first access point and the second access point, wherein the sequence numbers are used for indicating the sequences of the access points for replying to the station;
broadcasting, by the station, a communication message for enabling the first access point and the second access point to return reply messages to the station according to the sequence numbers in sequence, after receiving the communication message; and
receiving, by the station, a reply message returned by at least one access point in the first access point and the second access point, and performing data communication with the at least one access point which returns the reply message.

2. The method according to claim 1, wherein the receiving, by the station, the reply message returned by at least one access point in the first access point and the second access point, and performing data communication with the at least one access point which returns the reply message, comprises:
when receiving the reply message returned by the first access point within a first preset time, directly performing, by the station, data communication with the first access point without waiting for the second access point to return the reply message.

3. The method according to claim 2, wherein when receiving the reply message returned by the first access point within the first preset time, broadcasting, by the station, an acknowledgement message used for indicating that the reply message has been obtained, for enabling the second access point not to return the reply message after receiving the acknowledgement message, and performing, by the station, data communication with the first access point.

4. The method according to claim 1, wherein if only the first access point will actively return the reply message when receiving the communication message, and when not receiving the reply message returned by the first access point within the first preset time, the station broadcasts a request message used for requesting to return the reply message, for enabling the second access point to return the reply message after receiving the request message.

5. The method according to claim 1, wherein the receiving, by the station, the reply messages returned by at least one access point in the first access point and the second access point, and performing data communication with the at least one access point which returns the reply message, comprises:
if both the first access point and the second access point will return the reply messages when receiving the communication message, when the station receives the reply messages returned by the first access point and the second access point in sequence, selecting the access point with better channel quality in the information interaction to perform data communication according to the channel quality in the information interaction.

6. The method according to claim 1, wherein if the communication message is a request to send (RTS) and the reply message is a clear to send (CTS), the receiving, by the station, the reply message returned by at least one access point in the first access point and the second access point, and performing data communication with the at least one access point which returns the reply message, comprises:
receiving, by the station, the CTS returned by at least one access point in the first access point and the second access point;
determining the access point used for performing data communication according to the CTS returned by at least one access point in the first access point and the second access point; and
performing data communication with the access point determined to perform data communication.

7. The method according to claim 1, wherein if the first access point and the second access point work on the same channel, the station broadcasts the communication message on the channel; if the first access point and the second access point work on different channels, the station broadcasts the communication message on a channel which the first access point works, in the case of communication failure with the first access point, the station switches to a channel which the second access point works and broadcasts the communication message.

8. The method according to claim 1, wherein before performing, by the station, data communication with the at least one access point which returns the reply message, further comprising:
receiving, by the station, a communication setting message sent by an access point which has established a communication connection, and communicating with the access point which has established the communication connection according to the communication setting message;
wherein the communication setting message comprises at least one of the following information: communication time information and window length information.

9. A station, comprising:
a processor, configured to perform association certification with access points, wherein the access points at least comprises a first access point and a second access point;
a sender, configured to send sequence numbers to the first access point and the second access point, wherein the sequence numbers are used for indicating the sequences of the access points for replying to the station;
the sender, further configured to broadcast a communication message for enabling the first access point and the second access point to return reply messages to the station according to the sequence numbers in sequence, after receiving the communication message; and
a receiver, configured to receive a reply message returned by at least one access point in the first access point and the second access point, and perform data communication with the at least one access point which returns the reply message.

10. The station according to claim 9, wherein the receiver is specifically configured to:
when receiving the reply message returned by the first access point within a first preset time, directly perform data communication with the first access point without waiting for the second access point to return the reply message.

11. The station according to claim 10, when receiving the reply message returned by the first access point within the first preset time, indicate the sender to broadcast an acknowledgement message used for indicating that the reply message has been obtained, for enabling the second access point not to return the reply message after receiving the acknowledgement message, and the receiver performs data communication with the first access point.

12. The station according to claim 9, wherein if only the first access point will actively return the reply message when receiving the communication message, and when not receiving the reply message returned by the first access point within the first preset time, the receiver indicates the sender to broadcast a request message used for requesting to return the reply message, for enabling the second access point to return the reply message after receiving the request message.

13. The station according to claim 9, wherein the receiver is specifically configured to:
if both the first access point and the second access point will return the reply messages when receiving the communication message, when the receiver receives the reply messages returned by the first access point and the second access point in sequence, select the access point with better channel quality in the information interaction to perform data communication according to the channel quality in the information interaction.

14. The station according to claim 9, wherein if the communication message is a request to send (RTS) and the reply message is a clear to send (CTS), the receiver is specifically configured to:
receive the CTS returned by at least one access point in the first access point and the second access point;
determine the access point used for performing data communication according to the CTS returned by at least one access point in the first access point and the second access point; and
perform data communication with the access point determined to perform data communication.

15. The station according to claim 9,
the processor further configured to, if the first access point and the second access point work on the same channel, the sender broadcasts the communication message on the channel; if the first access point and the second access point work on different channels, the sender broadcasts the communication message on a channel which the first access point works, and in the case of communication failure with the first access point, the processor switches to a channel which the second access point works and indicates the sender to broadcast the communication message.

16. The station according to claim 9, wherein the receiver is further configured to:
receive a communication setting message sent by an access point which has established a communication connection, and communicate with the access point which has established the communication connection according to the communication setting message;
wherein the communication setting message comprises at least one of the following information: communication time information and window length information.

17. A system, comprising:
the station of claim 9;
at least two access points, configured to perform association certification with the station, receive corresponding sequence numbers sent by the station, wherein the sequence numbers are used for indicating the sequences of the access points for replying to the station, and when receiving a communication message broadcasts by the station, return reply messages to the station according to the sequence numbers in sequence, for enabling the station to receive the reply message returned by at least one access point and perform data communication with the at least one access point which returns the reply message.

18. The system according to claim 17, wherein if the station establishes a communication connection with any access point in the at least two access points, the access point, which has established the communication connection with the station, is further configured to send a communication setting message to the station, for enabling the station to perform data communication with the access point, which has established the communication connection with the station, according to the communication setting message;
wherein the communication setting message comprises at least one of the following information: communication time information and window length information.
